(19) United States
(12) Patent Application Publication
(10) Pub. No.: US 2006/0140748 A1
(43) Pub. Date: Jun. 29, 2006

(54) Method for channeling wind to produce electricity

(76) Inventor: Gabi Raziel, St. Jerusalem (IL)

Correspondence Address: DANIEL J SWIRSKY, 55 REUVEN ST., BEIT SHEMESH, 99544, IL

(21) Appl. No.: 10/531,266

(22) PCT Filed: Oct. 23, 2003
(86) PCT No.: PCT/IL03/00867

§ 371 Date: Apr. 13, 2005

(30) Foreign Application Priority Data
Oct. 28, 2002 (IL) 152518

(51) Int. Cl. F03B 15/06

(52) U.S. Cl. 415/4.1

(57) ABSTRACT

The present invention provides to a novel method for tunneling wind to walls or wind projectors, such as buildings and man-made construction, and than projecting said wind towards a plurality of wind turbines to produce electricity. This method especially adapted to convert the energy of terrestrial wind to electric or other usable energies. The present invnetion also provides a cost effective construction useful to convert a flow of terrestrial wind along the outer surface of a side of said construction into a usable energy.

### FIELD OF THE INVENTION

The present invention relates to a method for tunneling wind to produce electricity, and to a device adapted to this prepuce. More particularly, the present invention relates to a method for tunneling wind to walls or wind projectors, such as buildings and man-made construction, and than projecting said wind towards a plurality of wind turbines to produce electricity.

### BACKGROUND OF THE INVENTION

Many attempts were made to extract energy from wind. U.S. Pat. No. 4,265,086 to Bahrenburg discloses a terrestrial wind fence, adapted to extract energy from the wind and convert it into commercial electricity. The fence of this invention comprises multiple modules to form fences up to five hundred feet high up to five miles long. The construction of thousands and hundred of thousands of such modules in one fence is very costly, hard to handle and to manipulates and involved with tedious and considerably expensive maintenance.

### BRIEF DESCRIPTION OF THE FIGURES

In order to understand the invention and to see how it may be carried out in practice, a preferred embodiment will now be described, by way of non-limiting example only, with reference to the accompanying drawing, in which:

FIG. 1A schematically presents a top view of the construction according to one embodiment of the present invention; FIG. 1B shows the same in a side view; and FIG. 1B illustrates a side view of the construction according to another embodiment of the present invention, said construction is immobilized to a surface (e.g., a roof of a building) by means of an enforcement member (9B);

FIG. 2 schematically presents a top view of a construction according to another embodiment of the present invention comprising two walls and mutual wind pier;

FIG. 3A schematically presents a side and top view of a stack of two constructions. FIG. 3B shows the same in a side view, additionally comprising a turbine unit;

FIG. 4 schematically presents a side view of the upper unit of stack, comprising a weathercock member;

FIG. 5A schematically presents a side view of two walls made of breaks, concrete etc. FIG. 5B presents said walls, additionally comprising a mutual wind pier. FIG. 5C presents assembly of four such walls, having either horizontal or perpendicular oriented turbines. FIG. 5D presents a plurality of two horizontal turbines in communication with one axle, and lastly, FIG. 5E presents the very same, wherein two openings or more are used;

FIG. 6 schematically presents a lateral cross section of a wind pier according to yet another embodiment of the present invention; and,

FIG. 7 schematically illustrating another embodiment of the present invention wherein the wind is tunneled between the roof portion of the construction and the wind wall so a turbine is activated.

### SUMMARY OF THE INVENTION

It is thus the object of the present invention to present a cost effective method to convert the energy of terrestrial wind to electric or other usable energies. This method comprising interalia the following two steps;
a. constructing at least two elongated walls, wherein said walls form together a V shape, and said V shape has an open rim facing the direction from which the wind is usually blowing;
b. affixing one or more wind turbines in the vicinity of the close rim of said V shape;
   wherein said constructions collecting the wind and tunneling it throughout the open side towards close rim to the turbines, so that the energy of the wind is converted to a usable energy as the turbines are activated by the wind.

The energy generated by the wind is preferably an electrical energy, substantially transferred directly to an end user or gathered in a battery. Alternatively, the energy is adapted to be in use in cooling or heating units.

It is also another object of the present invention to provide an effective construction, especially useful to convert a flow of terrestrial wind along the outer surface of a side of said construction into a reusable energy. The construction is having the following ingredients: an elongated and gradually continuous wall member having a proximal and distal portion; a gradually rounded wind pier located adjacent to the proximal portion of said wall; having at least one opening; at least one wind turbine; and an exhaust, whereat wind is leaving the pier after the turbine was activated.

The said construction is potentially arranged as a perpendicular stack, comprising 2 to 20 individual constructions as defined above. The stack is built in the way so the bottom rim of an upper wall in attached effectively to a top rim of a wall located below, so a mutual wall of an increased surface are is obtained. In addition, a plurality of walls (preferably 2 to 8 walls) in communication with one wind pier can be used, wherein each wall is in communication with an opening of the wind pier. The above mentioned construction may comprises of means such as weathercock or weathervane, adapted to direct the wall or the opening towards the wind, so more winds are to be collected and more energy is generated.

The wind pier is preferably comprises of female or male threads having means to force the wind to flow in a predetermined wind tunnel. The said wind pier may comprise more then one-wind turbine and/or more then one opening. The wind turbine is preferably arranged either parallel or horizontal to the direction of wind flow.

It is acknowledged that at least one of the walls and/or constructions to be built exist, so one or more man-made walls and/or constructions are built in the method defined above. Moreover, the said existing construction is preferably selected from either man-made constructions or any pattern of the landscape, such as mountain cliffs, river valleys etc.

It is still in the scope of the present invention, to provide a building or an array of buildings, located gradually perpendicular to the terrestrial wind flow, comprising at least one wind turbine located in a wind pier, adapted to collect said wind along at least one face of said building, and to tunnel said wind to said turbine, so a energy is generated upon the activation of the turbine by said wind. The array of buildings defined above preferably having a central power center. The said power center comprises at least one wind pier, and wherein each said piers comprises at least one wind turbine, so wind flowing towards each of the buildings is tunneled to activate the said turbine so energy is generated.

### DETAILED DESCRIPTION OF THE INVENTION

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide for tunneling wind to convert air flow into energy.

The primary goal of the present invention is thus to provide a useful method to convert the energy of terrestrial wind to electric or other usable energies. Said method comprising the following steps:
a. constructing at least two elongated walls, wherein said walls form together a V shape, and said V shape has an open rim facing the direction from which the wind is usually blowing; and,
b. affixing one or more wind turbines in the vicinity of the close rim of said V shape.

Said constructions is collecting the wind and tunneling it throughout the open side towards close rim to the turbines, so that the energy of the wind is converted to a usable energy as the turbines are activated by the wind.

In the scope of the present invention, the term ‘terrestrial wind’ is referring to any wind blowing on the surface of earth, usually no higher than 1,000 ft then earth surface.

Another goal of the present invention is to present a construction, useful to convert a flow of terrestrial wind along the outer surface of a side of said construction into a usable energy. Said construction comprises one or more elongated walls. Said walls form together a V shape. Said V shape has an open rim facing the direction from which the wind is usually blowing. One or more wind turbines are affixed in the vicinity of the close rim of said V shape.

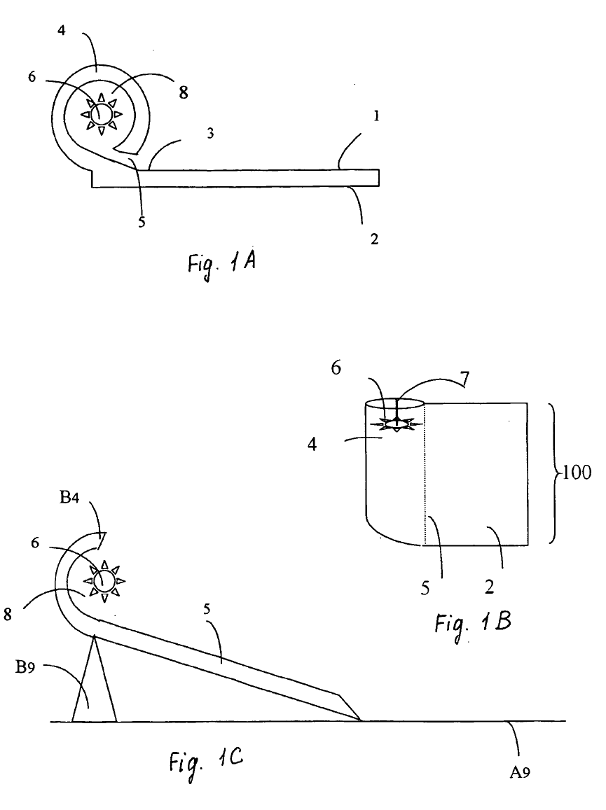

Reference is made now to FIG. 1A schematically presenting a construction adapted to tunnel wind to convert airflow into applicable and useable energy. The construction comprises a continuous and gradually rigid wall member located perpendicular to the direction of the wind flow. Said member, hereafter denoted in the term ‘wall’ (2), comprises a distal portion (1) and a proximal portion (3). Wind is tunneled by said wall to flow along the face of the wall from its distal portion (1) to its proximal portion (3). Adjacent the proximal end of the wall located a receiving cabinet (4) via a slit-like opening (5). The airflow is tunneled to flow inside said receiving cabinet (4) so it passing throughout a wind turbine (6). The preferred airflow in the receiving cabinet (4) is characterized by an upward direction, so the turbine (6) is situated horizontally. After the turbine was activated by said tunneled airflow, and energy is generated, airflow efflux is directed outside to the exhaust (8).

FIG. 1B schematically presents a side view of the construction. Its is clearly seen that the aforementioned construction is adapted to utilized as an incorporateable unit (100) comprising a wall member (2), and a receiving cabinet (4), interconnected in at least one face (the ‘inner face’) by means of an opening (5). Said receiving cabinet comprises at least one turbine (6) in communication with energy generator unit (not shown) by means of axle member (7), gear, bend assembly, mechanical shaft etc.

FIG. 1C schematically presents a side view of a construction according to yet another embodiment of the present invention, this construction also comprises a continuous and gradually rigid wall member located perpendicular to the direction of the wind flow. Adjacent the proximal end of the wall located a receiving cabinet (4) via a slit-like opening (5). The airflow is tunneled to flow inside said receiving cabinet (4) so it passing throughout a wind turbine (6) and leaving throughout an exhaust (8). Said construction is reinforced to the building construction (9A) (e.g., the buildings roof portion) by means of member 9B.

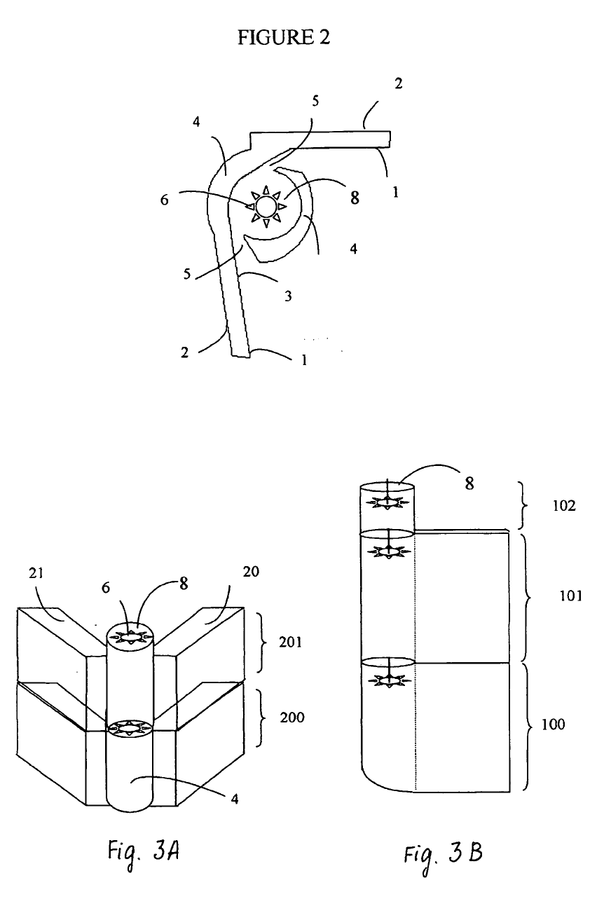

Reference is made now to FIG. 2, presenting the very same construction, characterized by two wall members, gradually perpendicular to each other in a gradually V shape. The open rim of the V is adapted to face the wind so the wind is tunneled towards the close rim of the V. Its is acknowledged in this respect that that more than two wall members are possible. A plurality of said walls is preferably in the range of one to six, though more wall members (2) are available per one receiving cabinet (4). Thus, an X shape, or any of its derivatives is possible. In this multi-member embodiment, wind is collected by each of said walls that are facing the wind, and tunneled from the distal portion of each wind (1) to the proximal portion (3). Than, the airflow is forced to enter mutual receiving cabinet (4) via one or more openings (5) so the turbine is activated by said airflow in its way out throughout one mutual or more exhausts (such as exhausts 8).

Reference is made now to FIG. 3A, schematically showing a side and top view of the hereto-defined construction having two walls arrange in a stack configuration, wherein unit 201 is located on the base unit 200, so walls 20 and 21 of the upper stack is located on the foundation of wall 20, 21 of the lower unit, respectively. The total area of the wall is thus duplicated, so more energy is to be regenerated. The figure also shows that more than one turbine can be used in one receiving cabinet (4).

FIG. 2B schematically shows a side view of the stack defined above, comprising two units, each of which comprises of both wall member and a receiving cabinet, and a unit 102, comprises only the receiving cabinet. All receiving cabinets are arranged in a row having one exhaust (8). Said architecture provides for higher efficiency in transforming the wind flow into useable energy.

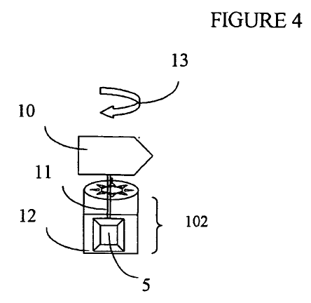

According to another embodiment of the present invention, the orientation of said units is regulated so the walls are kept gradually perpendicular to the direction of the wall influx. Said means are selected, yet not limited to active means, such as positioning gears in communication with a motor, or to passive means, such as weathercock (10), located on the most upper rim of unit 102, as schematically illustrated in FIG. 4. Said weathercock (10) is positioned by the airflow to a direction (13). The weathercock (10) is in communication with the opening (5) by means of axle (11). The opening (5), which is preferably perpendicular to the axis of the weathercock, is adapted to rotate or to slip in the direction (13) on a truck (12), located on the side wall of the receiving cabinet.

It is well in the scope of the present invention, wherein the walls and/or constructions as defined above, are made of flexible materials, such as rubber, elastic polymer composition etc. It is also in the scope of the present wherein said walls and/or constructions are made of rigid component, such as metals, glassware, cross-linked copolymers etc. A combination of the aforementioned material is especially preferable; such in a wall comprises a rigid skeleton and flexible body.

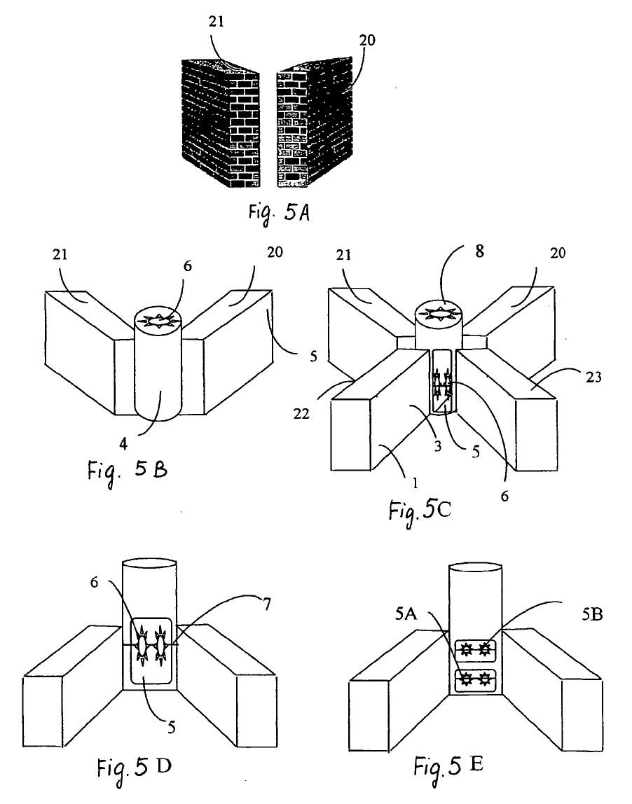

Moreover, it is a preferred embodiment of the present invention, wherein the walls and/or constructions are made of concrete, breaks etc. Thus, it is in the scope of the present invention wherein the walls and/or constructions are made of concrete wall, buildings, industrial plants and constructions. Reference is made now to FIG. 5A, showing the two walls compartment (20, 21) and a slit like opening (5) between them, characterized by that wind is tunneled to pass throughout the opening (5), preferably to the receiving cabinet as defined above. In this respect, it is clear that the present invention is highly relevant to any urbane, industrial or other man-made constructions characterized by that it is arranged in the way terrestrial wind is tunneled to a receiving cabinet.

Said housing, buildings, plants and other man-made constructions (hereto referred to blocks number 20 to 23) are presented in FIGS. 5B and 5C. FIG. 5B shows a plurality of two such buildings (20 and 21) attached to one wind pier having at least one turbine (6). FIG. 5C presents the same, having a plurality of four such buildings (20 to 23), wherein wind is collected in one such a mutual power-center. Terrestrial wind is collected in between said ‘walls’, so airflow is tunneled from the distal portion (1) to the proximal portion (3), then entering the said power-center (4) via the opening (5), to regenerate the desired power, before exiting the receiving cabinet via exhaust (8).

Reference is made now to FIG. 5D, schematically showing a side view of the unit defined above, comprising a plurality of horizontally directed wind turbine (6) in communication to an axle (7). Similarly, FIG. 5E is showing the very same unit, comprising more then one aforementioned plurality of wind turbines, namely 5a and 5b, whereas more then two openings and pluralities of turbines are possible.

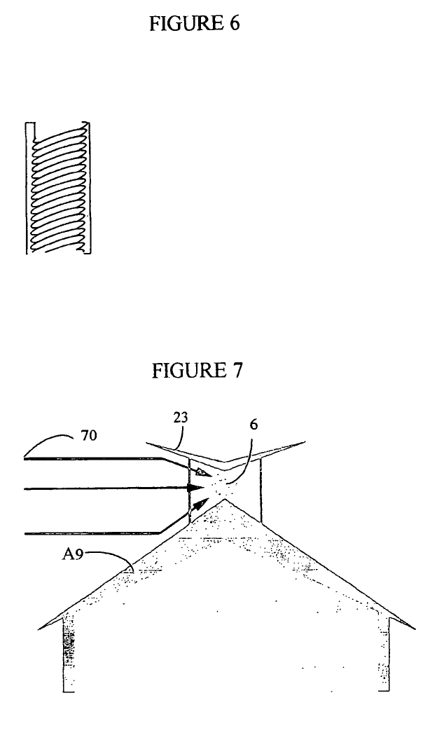

It is acknowledged that the receiving cabinet, as well as the aforementioned piers comprising means to circulate the tunneled wind upwards in a slalom movement. According to one embodiment of the present invention, schematically presented in its cross section in FIG. 6, said wind pathway in the receiving cabinet is gradually arranged as a female threads, having a main upwards longitudinal axis.

Reference is made now to FIG. 7 illustrating another embodiment of the present invention wherein the wind (70) is tunneled between the roof construction (9A) and the wall (23) so a horizontal or vertical turbine (6) is activated.

It is well in the scope of the present invention, wherein wind is tunneled in a duct or ducts to met a turbine. Thus, a general case is wherein an elongated wind-duct comprises a distal portion and a proximal portion. The proximal end preferably comprises wall projectors allowing wind to influx throughout opening. The tunneled airflow in the said duct is activating at least one turbine to produce energy, and then is leaving the said duct via an exhaust.

In this respect it is acknowledged that the said wind duct my be located either on static foundations, or on actuated or mobile platforms, as such as cars or any other vehicles, ships, planes, rail trains, cargo containers etc.

It is further in the scope of the present invention, wherein the aforementioned turbine is selected weather vane, propeller, booster, helix-like propeller or turbine of any size and shape. Said turbine may be affixed perpendicularly, horizontally or at any other configuration and orientation. Said turbine may provide for any suitable power source. In this respect, it is in the scope of the present invention wherein said power source is an electrical power. The electric power may be transferred to a battery or batteries, or directly transferred to the end users. Additionally or alternatively, the turbine may provide for air conditioning, in the manner condensed gas is provided. Alternatively, said-tunneled airflow may be used for cooling. Accordingly, the aforementioned construction may comprise the said wall or walls, and said receiving cabinet, wherein is the later the cooling process is provided. In such an embodiment, a turbine is not necessary, and heat exchanger units provide the cooling.

1. A method to convert the energy of terrestrial wind to electric or other usable energies, comprising interalia the following steps; a. constructing at least two elongated walls, wherein said walls form together a V shape, and said V shape has an open rim facing the direction from which the wind is usually blowing; and, b. affixing one or more wind turbines in the vicinity of the close rim of said V shape; wherein said constructions collecting the wind and tunneling it throughout the open side towards close rim to the turbines, so that the energy of the wind is converted to a usable energy as the turbines are activated by the wind.

2. The method according to claim 1, comprising the following steps; a. collecting the wind along the side of a wall member of a construction, in a movement beginning from the distal portion of the wall to its proximal portion, whereat a wind pier is located; b. tunneling said wind to flow throughout at least one turbine located inside said pier; c. generating energy as the turbine is activated by the wind; and, d. exhausting the said wind outside said pier.

3. The method according to claim 1, wherein the energy generated by the wind is electrical energy.

4. The method according to claim 3, wherein the electric power is substantially transferred directly to an end user or gathered in a battery.

5. The method according to claim 1, adapted for use in cooling units, wherein the energy is use for cooling or heating.

6. The method according to claim 1, wherein the construction is selected from walls, fences, buildings, houses, industrial plants, or any other man-made constructions.

7. A construction useful to convert a flow of terrestrial wind along the outer surface of a side of said construction into a usable energy; wherein said construction comprises at least two elongated walls; further wherein said walls form together a V shape, and said V shape has an open rim facing the direction from which the wind is usually blowing; and wherein one or more wind turbines are affixed in the vicinity of the close rim of said V shape.

8. The construction according to claim 7, comprising only one elongated wall.

9. The construction according to claim 7, comprising; a. an elongated and gradually continuous wall member having a proximal approaching the close rim of the v shape, and distal portion facing the open rim of the shape; b.a gradually rounded wind pier located adjacent to the proximal portion of said wall; having at least one opening; c. at least one wind turbine; and, d. an exhaust, whereat wind is leaving the pier after the turbine was activated.

10. The construction according to claim 9, wherein said proximal portion of the wall is having means to direct the wind, flowing from a predetermined direction, to the distal portion of said barrier.

11. The construction according to claim 9, wherein said distal portion of the wall is having means to project the wind, flowing from the direction of the proximal portion of the barrier, to a wind pier.

12. The construction according to claim 9, wherein a plurality of said constructions is arranged in a perpendicular stack configuration.

13. The stack according to claim 12, comprising a plurality of 2 to 20 individual ones of said constructions.

14. The stack according to claim 13, adapted so the bottom rim of a upper wall in attached effectively to a top rim of a wall located below, so a mutual wall of an increased surface are is obtained.

15. The construction according to claim 7, comprising a plurality of walls in communication with one wind pier, each wall is in communication with an opening of the wind pier.

16. The construction according to claim 15, comprises 2 to 8 walls.

17. The construction according to claim 15, comprises 2 to 4 walls.

18. The construction according to claim 16, comprises an X shape, wherein the wind is collected and tunneled towards the turbine from more than one direction.

19. The construction according to claim 9, additionally comprising means to direct the wall or the opening towards the wind, so more winds are to be collected and more energy is generated.

20. The construction according to claim 19, comprising weathercock or weathervane adapted to direct the wall or the opening towards the wind.

21. The construction according to claim 9, wherein the wind pier comprising female or male threads having means to force the wind to flow in a predetermined wind tunnel.

22. The construction according to claim 9, wherein the wind pier comprising more then one wind turbine.

23. The construction according to claim 9, wherein the wind pier comprising more then one opening.

24. The construction according to claim 9, wherein the wind turbine is arranged either parallel or horizontal to the direction of wind flow.

25. The construction according to claim 9, wherein the wall is selected from walls, fences, buildings, houses, industrial plants, or any other man-made constructions.

26. The construction according to claim 9, wherein the wall is at least partially made of flexible materials, selected from polymers, rubbers, linen, cloths or any combination thereof.

27. The construction according to claim 9, wherein the wall is at least partially made of rigid materials, selected from cross-linked polymers, metals, glassware, composite materials or any combination thereof.

28. (canceled)

29. The construction according to claim 7, selected from either man-made constructions or any pattern of the landscape.

30. A building or an array of buildings, located gradually perpendicular to the terrestrial wind flow, comprising at least one wind turbine located in a wind pier, adapted to collect said wind along at least one face of said building, and to tunnel said wind to said turbine, so a energy is generated upon the activation of the turbine by said wind.

31. The array of buildings according to claim 30, having a central power center, wherein said power center comprises at least one wind pier, and wherein each said piers comprises at least one wind turbine, so wind flowing towards each of the buildings is tunneled to activate the said turbine so energy is generated.
